(19) United States
(12) Patent Application Publication
(10) Pub. No.: US 2026/0062327 A1
(43) Pub. Date: Mar. 5, 2026

(54) MEMBRANE TREATMENT OF WATER CONTAINING FREE OIL

(71) Applicant: Ecolab USA Inc., Saint Paul, MN (US)

(72) Inventor: Seong-Hoon Yoon, Naperville, IL (US)

(21) Appl. No.: 19/311,681

(22) Filed: Aug. 27, 2025

Related U.S. Application Data
(60) Provisional application No. 63/688,588, filed on Aug. 29, 2024.

(51) Int. Cl. C02F 1/56; C02F 1/00; C02F 1/44; C02F 1/52; C02F 101/32; C02F 103/16

(52) U.S. Cl. CPC C02F 1/56; C02F 1/004; C02F 1/5236; C02F 1/44; C02F 2101/32; C02F 2103/16; C02F 2305/04

(57) ABSTRACT

An oil-containing wastewater can be chemically treated to provide a treated wastewater that is then subject to membrane filtration. Chemical treatment of the oil-containing wastewater can reduce membrane fouling by contaminants, such as oily and colloidal contaminants, allowing a wastewater that may not otherwise be practically treated using a membrane to be treated using the membrane. The oil-containing wastewater can be pretreated with a surfactant and a high molecular weight cationic flocculant, e.g., in combination with a coagulant and an acid and/or base to adjust the pH of the wastewater to a level effective for performance of the coagulant and/or flocculant.

### RELATED APPLICATION

This application claims priority to U.S. Provisional Application No. 63/688,588, filed Aug. 29, 2024, the entire contents of which are hereby incorporated by reference.

### TECHNICAL FIELD

This disclosure relates to membrane systems and techniques and, more particularly, to membrane systems and techniques for treating oily wastewater.

### BACKGROUND

Oily wastewaters containing hydrocarbons are produced in various industries including the machining and fabrication industries, steel and aluminum industries, chemical processing industry, automotive industry, laundry industry, and crude oil recovery and refining industries. Example emulsified hydrocarbons include lubricants, cutting fluids, tars, grease, crude oils, diesel oils, gasoline, kerosene, jet fuel, and the like. In the case of machining fluids, the oily wastewaters may include metal cuttings, emulsified hydrocarbons, colloidal contaminants, and the like.

Residual hydrocarbon can be removed prior to discharge of the water to the environment or reuse of the water in the industrial process. In addition to ecological concerns and governmental regulations, efficient removal of emulsified hydrocarbons is beneficial for economic reasons as use of water containing emulsified oil in industrial processes may result in decreased production and increased operational costs for the industry involved.

In some industries, oily wastewater may be treated onsite to reduce the concentration of oil and other contaminants from the wastewater. In other applications, particularly when dealing with heavily fouled wastewater such as wastewater generated during metal machining operations, the water may be transported offsite to an external service provider for processing. Reducing or eliminating the amount of contaminated water that needs to be transported can be beneficial to minimize the environmental risks associated with wastewater transfer and transport as well as to minimize the significant cost of such a process.

### SUMMARY

In general, this disclosure is directed to systems and techniques for treating an oil-containing wastewater using a combination of chemical treatment and membrane filtration. In some examples, the oil-containing wastewater can be chemically treated to provide a treated wastewater that is then subject to membrane filtration. Chemical treatment of the oil-containing wastewater can reduce membrane fouling by contaminants, such as oily and colloidal contaminants, allowing a wastewater that may not otherwise be practically treated using a membrane to be treated using the membrane.

The oil-containing wastewater can be pretreated with a variety of different chemicals. The oil-containing wastewater may be treated with a surfactant to emulsify free oils in the oil-containing wastewater. The oil-containing wastewater may additionally or alternatively be treated with a flocculant and/or coagulant for dispersing or treating colloidal (or suspended) contaminants in the oil-containing wastewater. A coagulant may neutralize the negative charges on particles allowing the particles to stick together and form clumps called microflocs. A flocculant may physically bind coagulated particles together to form larger clumps called flocs. The oil-containing wastewater may also be treated with an acid and/or base to adjust the pH of the wastewater to a level effective for performance of the coagulant and/or flocculant.

In some specific examples, the oil-containing wastewater is treated with a comparatively high molecular weight polymeric flocculant, such as a comparatively high molecular weight cationic polymeric flocculant. The flocculant may have a molecular weight of at least 1,000,000 Da, such as at least 5,000,000 Da, at least 10,000,000 Da, or at least 15,000,000 Da. In some applications, it has been observed that pretreating an oil-containing wastewater through addition of one or more treatment chemicals that includes a high molecular weight cationic polymeric flocculant can significantly improve the processability of the treated water using a membrane as compared to other types of chemical pretreatment applications.

While any oil-containing wastewaters can be treated according to the system, chemistries, and techniques of the disclosure, in some cases, the wastewater treated is a wastewater from a metal milling process and/or a die casting process. Such wastewater sources may be particularly challenging to filter using a membrane because of the comparatively high amounts of heavy oil in the water and the presence of other contaminating agents (e.g., mold release chemicals, metal cutting chemical aids, suspended solids).

In one example, a method of treating oil-containing water for membrane filtration is described. The method includes adding a cationic polymeric flocculant having a molecular weight of at least 1,000,000 Da and a surfactant to an oil-containing wastewater to form a treated wastewater. The method further includes supplying the treated wastewater to a membrane and generating therefrom a permeate stream and a concentrate stream.

In another example, a method of treating oil-containing water for membrane filtration is described. The method includes adding a cationic polymeric flocculant having a molecular weight of at least 1,000,000 Da, a coagulant, and a surfactant to an oil-containing wastewater to form a treated wastewater. The example specifies that the oil-containing wastewater includes wastewater from a metal milling process and/or a die casting process. The method further involves supplying the treated wastewater to a membrane and generating therefrom a permeate stream and a concentrate stream.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example system for chemically pretreating an oil-containing wastewater to form a treated water and subsequently membrane separating the treated water.

FIG. 2 shows three jars of the wastewater: one containing the raw wastewater and two treated with different pretreatment chemicals.

FIG. 3 shows flux data of various samples with and without preconditioning.

FIG. 4 is a bar graph showing the filterability of the wastewater under different pretreatment chemical conditions.

FIG. 5 is a plot of the filterability of three wastewater samples treated with different molecular weight flocculants.

### DETAILED DESCRIPTION

This disclosure is generally directed to systems and technique for chemically treating oil-containing wastewater to increase the processability of the wastewater and subsequently performing a membrane separation process on the treated wastewater using one or more membrane separation devices. The membrane separation device may be a reverse osmosis membrane (RO), a nanofiltration membrane (NF), an ultrafiltration membrane (UF), microfiltration membrane (MF), or other type of membrane separation device. The form of the membrane is not limited, and any type of membrane module may be used such as spiral wound type membrane module, hollow-fiber membrane module, tubular type membrane module, and plane type membrane module. Although the membrane separation process can be used for any desired application, the separation process may commonly be deployed for water treatment and purification of oil-containing water.

The oil-containing wastewater may be generated in a machining and/or fabrication process, from a steel and/or aluminum fabrication process, in a chemical industry process, in an automotive industry process, from a laundry process, from a crude oil recovery and/or refining process, and/or other process in which wastewater containing oil is generated and desirably processed for purification.

In some examples, the wastewater treated according to examples of the disclosure is generated from a metal milling process. In a metal milling process, a rotary cutter may be used to remove material by advancing a cutter relative to a metal workpiece along one or more axes. A cutting fluid may be used to cool the workpiece at the location of cutting and/or convey cut material away from the cutting head. The cutting fluid may include water soluble cutting oil and/or cutting fluid chemical aid(s). In either case, the metal milling process may generate an oil-containing wastewater. The oil-containing wastewater may include chips or particles of cut metal, which can be gravity separated or bulk filtered from the wastewater before the wastewater undergoes further processing as described herein.

As another example, the wastewater treated according to examples of the disclosure is wastewater generated from a die casting process. In a die casting manufacturing process, molten metal can be poured or forced into a mold. The mold—also known as a tool or die—is typically fabricated from steel and specially designed for each project. The die casting industry uses water to cool and carry lubricants to the casting dies. The resulting wastewater can include various oils, hydrocarbons, heavy metals, and silicones that make it unsuitable for direct discharge to the environment.

While the composition of the oil-containing wastewater can vary depending on the source, in some applications, the oil-containing wastewater has at least 1 mg/L of oil, such as at least 5 mg/L, at least 10 mg/L, at least 25 mg/L, at least 50 mg/L, at least 100 mg/L, at least 150 mg/L, at least 200 mg/L, at least 250 mg/L, such as at least 300 mg/L, at least 350 mg/L, at least 400 mg/L, at least 450 mg/L, from 250 mg/L to 1000 mg/L, from 350 mg/L to 1000 mg/L, from 400 mg/L to 600 mg/L, or from 650 mg/L to 850 mg/L. The oil component of the wastewater is generally liquid although may include a solid fraction. The hydrocarbons forming the oil component of the wastewater can include both cyclic and acyclic (aliphatic) compounds, which includes both saturated and mono- or polyunsaturated compounds. The hydrocarbons may be linear or branched. In examples, the oil-containing wastewater includes at least 70 wt % water, such at least 80 wt % water, at least 90 wt % water, at least 95 wt % water, at least 98 wt % water, or at least 99 wt % water.

In various examples, the oil in the wastewater is a vegetable oil, an animal derived oil, and/or or petrochemical type oil, such as a Group I type oil, a Group II type oil, a Group III type oil, a Group IV type oil, a Group V type oil and combinations thereof. A “vegetable oil” is a triglyceride extracted from a plant. This can include oils that are liquid at room temperature, or oils that are solid at room temperature are sometimes called vegetable fats. Vegetable oils are composed of triglycerides, as contrasted with waxes which lack glycerin in their structure. Most, but not all vegetable oils are extracted from the fruits or seeds of plants. In some examples, the vegetable/animal oils used for the base of the industrial lubricant may be methyl esters of fatty acids or triglycerides (C5-C22) derived from vegetable seeds or animal fats. The methyl esters of fatty acids or triglycerides can be derived synthetically or from natural products, such as lard, tallow, soybean oil, coconut oil, rapeseed (canola) oil, peanut oil, sunflower oil, or crambe oil. These natural oils typically contain C16 palmitic acid, and C18 stearic, oleic, linoleic, and linolenic. The methyl ester of a fatty acid may be a methyl ester of oleic, linoleic, linolenic, palmitic, or stearic acid, naturally derived or synthetically produced, or combination.

In some examples, the oil is or includes a petrochemical-based oil, e.g., Group I, II, III, IV, and/or V type oil. When describing an oil bases using the terms “Group” and a roman numeral of, e.g., I-V, these terms are describing a type of oil composition as designated by the American Petroleum Institute (API). Group I base oils are classified as less than 90 percent saturates, greater than 0.03 percent sulfur(S) with a viscosity-index range of 80 to 120. In some applications, the temperature range for these oils is from 32 degrees F. to 150 degrees F. Group I base oils can be manufactured by solvent extraction, solvent or catalytic dewaxing, and hydro-finishing processes. Common Group I base oil may include 150SN (solvent neutral), 500SN, and 150BS (brightstock). Group I base oils are typically mineral oils.

Group II base oils are defined as being more than 90 percent saturates, less than 0.03 percent sulfur and with a viscosity index of 80 to 120. Group II base oils can be often manufactured by hydrocracking. Group II base oils are also typically mineral oils.

Group III base oils are defined as being greater than 90 percent saturates, less than 0.03 percent sulfur and have a viscosity index above 120. These oils are refined even more than Group II base oils and generally are hydrocracked with a higher pressure and heat than Group II. Group III base oils are sometimes described as synthesized hydrocarbons. Group III base oils can be manufactured by processes, such as isohydromerization, and can be manufactured from base oil or slax wax from dewaxing process.

Group IV base oils are polyalphaolefins (PAOs). These synthetic base oils are made through a process called synthesizing. More specifically, in some examples, the process may begin with oligomerisation of alpha olefins and a catalyst. Oligomerization is followed by distillation. The oligomerization and distillation steps may include steam cracking hydrocarbons to produce ultra high-purity ethylene, ethylene oligomerization to develop 1-decene and 1-dodecene, and decene or dodecene oligomerization to form a mixture of dimers, trimers, tetramers and higher oligomers. Distillation is followed by hydrogenation including hydrogen and a catalyst. Group IV base oils typically have a viscosity index of at least 140.

Group V base oils are classified as all other base oils, including silicone, phosphate ester, polyalkylene glycol (PAG), polyolester, biolubes, etc. These base oils are at times mixed with other base stocks, such as the aforementioned Group I, II, III and IV base oils. An example would be polyalphaolefin (PAO) that is mixed with a polyolester. Esters are common Group V base oils used in different lubricant formulations to improve the properties of the existing base oil. Examples of synthetic oils include olefins, isomerized olefins, synthetic esters, phosphate esters, silicate esters, polyalkylene glycols, etc.

The oil-containing wastewater may additionally or alternatively include suspended solids. Example chemical components forming the suspended solids may include amorphous or crystalline colloidal silica, silt/soil particles, metals debris, metal oxides such (e.g., TiO₂, Al₂O₃, Fe₂O₃, ZrO₂, Al₂O₃ and combinations thereof), metal hydroxides, microbial floc, debris originated from plants/animals, and the like, and combinations thereof. Suspended solids in the oil-containing wastewater can be measured according to United States Environmental Protection Agency (EPA) Total Suspended Solids (TSS) measurement method 160.2 (1999). In some applications, the oil-containing wastewater includes suspended solids at a concentration of at least 1 mg/L, such as at least 5 mg/L, at least 10 mg/L, at least 25 mg/L, at least 50 mg/L, at least 100 mg/L, at least 150 mg/L, at least 200 mg/L, such as at least 250 mg/L, at least 300 mg/L, at least 400 mg/L, at least 500 mg/L, from 250 mg/L to 1000 mg/L, from 250 mg/L to 550 mg/L, or from 550 mg/L to 850 mg/L. In applications, the suspended solids may be primarily composed of silica. For example, the suspended solids may be composed of at least 50 wt % silica, such as at least 60 wt %, at least 70 wt %, at least 80 wt %, or at least 90 wt %.

Independent of the composition of the oil-containing wastewater, the wastewater can be treated using systems, compositions, and techniques according to the present disclosure. Treatment of the oil-containing wastewater can involve adding a flocculant to the oil-containing wastewater. A flocculant is a chemical that induces flocculation (e.g., it induces the enhanced agglomeration of material suspended within a liquid either alone or after coagulation).

In some applications, the flocculant combined with the oil-containing wastewater is a cationic polymeric flocculant, which has a positive charge that is beneficial for flocculating charged particulates typically found in oil-containing wastewater sources. In some examples, the cationic polymeric flocculant used to treat the oil-containing wastewater has a cationic mole charge from 30% to 70%, such as from 40% to 60%. Example cationic polymeric flocculants that can be used include a polydimethylaminoethylacrylate methyl chloride, a polydimethylaminoethylmethacrylate methyl chloride, a polydimethylaminoethylmethacrylate methyl sulfate, a polydimethylaminoethylacrylate methyl sulfate, a polydimethylaminocthylmethacrylate benzyl chloride, a polydimethylaminoethylacrylate benzyl chloride, a polytrimethylammonium propyl methacrylamide chloride, a polyacrylamidopropyltrimethylammonium chloride, an acrylamide-dimethylaminoethylacrylate methyl chloride copolymer, an acrylamide-dimethylaminoethylmethacrylate methyl chloride copolymer, an acrylamide-dimethylaminoethylmethacrylate methyl sulfate copolymer, an acrylamide-dimethylaminoethylacrylate methyl sulfate copolymer, an acrylamide-dimethylaminoethylmethacrylate benzyl chloride copolymer, an acrylamide-dimethylaminoethylacrylate benzyl chloride copolymer, an acrylamide-trimethylammonium propyl methacrylamide chloride copolymer, an acrylamide-acrylamidopropyltrimethylammonium chloride copolymer, and combinations thereof. In one specific example, the cationic polymeric flocculant is or includes polydimethylaminoethylacrylate methyl chloride.

Additionally or alternatively, the flocculant used for treating the oil-containing wastewater may be an anionic polymeric flocculant. The anionic polymeric flocculant may have an anionic mole charge from about 30% to about 40%. Example anionic polymeric flocculant that may be using are a polyacrylamide, a polyacrylate, a poly(meth)acrylate, a poly 2-acrylamido-2-methylpropoane sulfonic acid, an acrylamide sodium acrylate copolymer, an acrylamide sodium(meth)acrylate copolymer, an acrylamide/ammonium acrylate copolymer, an acrylamide ammonium(meth)acrylate copolymer, an acrylamide sodium 2-acrylamido-2-methylpropane sulfonic acid copolymer, an acrylamide ammonia 2-acrylamido-2-methylpropane sulfonic acid copolymer, a hydrolyzed acrylamide (to acrylic add) 2-acrylamido-2-methylpropane sulfonic add copolymer, and/or an acrylamide 2-acrylamido-2-methylpropane sulfonic acid/ammonium acrylate terpolymer.

The polymeric flocculant used to treat the oil-containing wastewater may have a comparatively high molecular weight, which has been found in some applications to exhibit significantly improved performance compared to using a lower molecular weight flocculant. The polymeric flocculant can have a molecular weight of at least 1,000,000 Daltons (Da), such as at least 5,000,000 Da, at least 10,000,000 Da, or at least 15,000,000 Da. For example, the molecular weight of the polymeric flocculant may be within a range from 5,000,000 Da to 25,000,000 Da, such as from 10,000,000 Da to 20,000,000 Da.

The amount of polymeric flocculant added to the oil-containing wastewater may vary, e.g., depending on the concentration and composition of contaminants in the wastewater. In general, the amount of polymeric flocculant added to the oil-containing wastewater may be effective to promote effective flocculation of contaminants in the wastewater. In some applications, the amount of the polymeric flocculant added to the oil-containing wastewater is effective to provide a concentration of the polymeric flocculant in the treated wastewater of at least 0.05 per million (ppm) flocculant, such as at least 0.1 ppm, at least 0.5 ppm, at least 1 ppm, at least 5 ppm, at least 10 ppm, at least 25 ppm, at least 50 ppm, at least 75 ppm, or at least 100 ppm. For example, the amount of the polymeric flocculant added to the oil-containing wastewater may be effective to provide a concentration of the polymeric flocculant in the treated wastewater within a range from 25 ppm to 500 ppm, such as from 50 ppm to 250 ppm.

Treatment of the oil-containing wastewater can also involve adding a surfactant to the oil-containing wastewater. A surfactant can reducer interfacial tension breakdown oil molecules in the oil-containing wastewater. The surfactant may be selected to be compatible with other chemical compounds in the oil-containing wastewater and also used to chemically pretreat the oil-containing wastewater. Examples of different surfactants that may be used to treat the oil-containing wastewater include water soluble or water dispersible nonionic, semi-polar nonionic, anionic, cationic, amphoteric, and zwitterionic surfactants, and combinations thereof.

In some applications, an anionic surfactant is added to the oil-containing wastewater. A surfactant may be categorized as anionic because the charge on the hydrophobe is negative (although the hydrophobic section of the molecule may carry no charge unless the pH is elevated to neutrality or above, such as in the case of a carboxylic acids). Carboxylate, sulfonate, sulfate and phosphate are examples of the polar (hydrophilic) solubilizing groups found in many anionic surfactants. The cations (counter ions) associated with these polar groups may include sodium, lithium, and/or potassium to impart water solubility; ammonium and/or substituted ammonium ions to provide both water and oil solubility; and, calcium, barium, and/or magnesium to promote oil solubility.

Anionic surfactants that may be used include linear and branched primary and secondary alkyl sulfates, alkyl ethoxysulfates, fatty oleyl glycerol sulfates, alkyl phenol ethylene oxide ether sulfates, the C5-C17 acyl-N—(C1-C4 alkyl) and —N—(C1-C2 hydroxyalkyl) glucamine sulfates, and sulfates of alkylpolysaccharides such as the sulfates of alkylpolyglucoside. In some examples, the anionic surfactant is a synthetic, water soluble anionic surfactant compound that includes the ammonium and substituted ammonium (such as mono-, di- and triethanolamine) and alkali metal (such as sodium, lithium and potassium) salts of the alkyl mononuclear aromatic sulfonates such as the alkyl benzene sulfonates containing from about 5 to about 18 carbon atoms in the alkyl group in a straight or branched chain, e.g., the salts of alkyl benzene sulfonates or of alkyl toluene, xylene, cumene and phenol sulfonates; alkyl naphthalene sulfonate, diamyl naphthalene sulfonate, and dinonyl naphthalene sulfonate and alkoxylated derivatives. Other anionic surfactants that may be used include olefin sulfonates, such as long chain alkene sulfonates, long chain hydroxyalkane sulfonates or mixtures of alkenesulfonates and hydroxyalkane-sulfonates. Accordingly, in some examples, the anionic surfactant is added to the oil-containing wastewater is selected from the group consisting of: an alkyl aryl sulfonate, an olefin sulfonate, a paraffin sulfonate, an alcohol sulfate, an alcohol ether sulfate, an alkyl carboxylate, an alkyl ether carboxylate, an ethoxylated alkyl phosphate ester, a monoalkyl sulfosuccinate, a dialkyl sulfosuccinate, a monoalkyl sulfosuccinamate, a dialkyl sulfosuccinamate, and combinations thereof.

The amount of surfactant added to the oil-containing wastewater may vary, e.g., depending on the concentration and composition of contaminants in the wastewater. In some applications, the amount of the surfactant added to the oil-containing wastewater is effective to provide a concentration of the surfactant in the treated wastewater of at least 10 parts per million (ppm) surfactant, such as at least 25 ppm, at least 50 ppm, at least 75 ppm, at least 100 ppm, at least 125 ppm, or at least 150 ppm. For example, the amount of the surfactant added to the oil-containing wastewater may be effective to provide a concentration of the surfactant in the treated wastewater within a range from 25 ppm to 1000 ppm, such as from 50 ppm to 500 ppm, from 75 ppm to 250 ppm, or from 100 ppm to 200 ppm.

Treatment of the oil-containing wastewater can additionally or alternatively involve adding a coagulant to the oil-containing wastewater. A coagulant is a chemical that can induce initial agglomeration of contaminants suspended within the oil-containing wastewater. In some applications, the coagulant used has a lower molecular weight than the flocculant and/or may have a high density of cationic charge groups. The coagulant may be inorganic or organic. Example inorganic metal salt coagulants that may be used include alum, sodium aluminate, polyaluminum chlorides or PACs (which also may be under the names aluminum chlorohydroxide, aluminum hydroxide chloride, and polyaluminum hydroxychloride), sulfated polyaluminum chlorides, polyaluminum silica sulfate, ferric sulfate, ferric chloride, and the like and combinations thereof.

Organic polymeric coagulants that may be used include epichlorohydrin-dimethylamine (EPI-DMA) copolymers and cationically charged vinyl addition polymers such as polymers, copolymers, and terpolymers of (meth)acrylamide, diallyl-N,N-disubstituted ammonium halide, dimethylaminoethyl methacrylate and its quaternary ammonium salts, dimethylaminoethyl acrylate and its quaternary ammonium salts, methacrylamidopropyltrimethylammonium chloride, diallylmethyl(beta-propionamido)ammonium chloride, (beta-methacryloyloxyethyl)trimethyl ammonium methylsulfate, quaternized polyvinyllactam, vinylamine, and acrylamide or methacrylamide that has been reacted to produce the Mannich or quaternary Mannich derivatives, and combinations thereof. When used, the coagulant may have a molecular weight less than 1,000,000 Daltons (Da), such as from 20,000 to 1,000,000 Da.

In some applications, the amount of the coagulant added to the oil-containing wastewater is effective to provide a concentration of the coagulant in the treated wastewater of at least 10 parts per million (ppm) surfactant, such as at least 250 ppm, from 500 ppm to 5000 ppm, or from 1000 ppm to 2500 ppm.

Treatment of the oil-containing wastewater may involve adjusting the pH of the oil-containing wastewater. The pH of the oil-containing wastewater may be adjusted to a pH range effective for enhancing the performance of the other constituent treatment chemicals added to the oil-containing wastewater during treatment. The pH of the wastewater may be adjusted by lowering the pH of the oil-containing wastewater through addition of an acid to the wastewater (e.g., a mineral acid (e.g., hydrochloric acid; phosphoric acid; sulfuric acid; nitric acid) and/or an organic acid (e.g., lactic acid, acetic acid, hydroxyacetic acid, citric acid, glutamic acid, glutaric acid, gluconic acid)) or by increasing the pH of the oil-containing wastewater through addition of a base to the wastewater (e.g., an alkali metal hydroxide or carbonate, an alkaline earth hydroxide or carbonate). In some examples, the oil-containing wastewater may be adjusted to a pH with a range from 5 to 9, such as from 5 to 7, from 7 to 9, or from 6 to 8.

The oil-containing wastewater can be chemically treated by combining the individual treatment chemicals (e.g., flocculant, surfactant, coagulant, and/or pH adjuster) with the oil-containing wastewater from the source. The treatment chemicals may be added separately to the oil-containing wastewater either in series or in parallel. Additionally or alternatively, one or more of the treatment chemicals may be combined together and introduced simultaneously into the oil-containing wastewater through a single stream.

The treatment chemical can be added inline to a flowing stream of the oil-containing wastewater, e.g., with the flow stream of the wastewater containing the treatment chemicals passed through a mixing device. The treatment chemicals can be added to a fixed volume of the oil-containing wastewater, e.g., in a treatment vessel where the chemicals are allowed to intermix with the oil-containing wastewater in the vessel. The vessel may include one or more active mixing devices (e.g., paddle mixers) to intermix the treatment chemicals with the wastewater.

Independent of whether the treatment chemicals are added to a static or flowing volume of the oil-containing wastewater, the treatment chemicals may be allowed to interact and react with the oil-containing wastewater and contaminants therein for a period of time before supplying the resulting treated wastewater to a membrane separation device. The period of time may be at least 5 seconds, such as at least 10 seconds, at least 30 seconds, at least 1 minute, at least 2 minutes, at least 3 minutes, at least 5 minutes, at least 7 minutes, at least 10 minutes, or at least 15 minutes. For example, the period of time may range from 5 seconds to 30 seconds, from 5 seconds to 10 seconds, from 1 minute to 10 minutes, or from 1 minute to 5 minutes. The treated wastewater can then be supplied to a membrane separation device, causing the treated wastewater to contact the membrane to generate a comparatively clean permeate water stream and a contaminate concentrate stream.

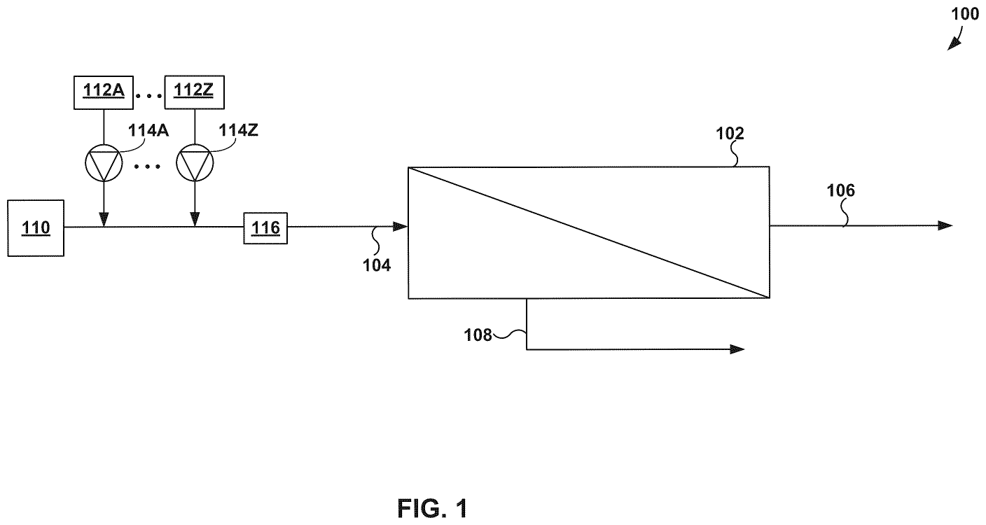

FIG. 1 is a conceptual diagram illustrating an example system for chemically pretreating an oil-containing wastewater to form a treated water and subsequently membrane separating the treated water. System 100 includes a separation membrane 102 that receives a treated water feed stream 104 from a fluid pathway. During operation of system 100, membrane 102 can be contacted with the feed stream liquid to separate the feed stream into a permeate stream 106 and a retentate stream 108 (which may also be referred to as a concentrate stream 108). Upon separation of the feed stream into permeate stream 106 and concentrate stream 108, in membrane 102, the permeate stream 106 can contain a substantially lower concentration of larger size molecules as compared to the feed stream. On the other hand, the concentrate stream 108 can have a higher concentration of the larger size molecules as compared to the feed stream. In this regard, the permeate stream 106 represents a comparatively purified water stream while concentrate contains an increased concentration of the contaminants present in feed stream 104.

System 100 and membrane 102 can be configured for any desired type of membrane separation process, including cross flow separation processes, dead-end flow separation processes, reverse osmosis, ultrafiltration, microfiltration, nanofiltration, electrodialysis, electrodeionization, pervaporation, membrane extraction, membrane distillation, membrane stripping, membrane aeration and the like or combinations thereof. Typically, however, system 100 and membrane 102 may be implemented as an ultrafiltration, microfiltration, or nanofiltration membrane separation process.

In most membrane applications, the feed stream is processed under cross flow conditions. When so configured, the feed stream may flow substantially parallel to the membrane surface such that only a portion of the feed stream diffuses through the membrane as permeate. The cross flow rate is typically high in order to provide a scouring action that lessens membrane surface fouling. This can also decrease concentration polarization effects (e.g., concentration of solutes in the reduced-turbulence boundary layer at the membrane surface, which can increase the osmotic pressure at the membrane and thus can reduce permeate flow). The concentration polarization effects can inhibit the feed stream water from passing through the membrane as permeate, thus decreasing the recovery ratio, e.g., the ratio of permeate to applied feed stream. A recycle loop(s) may be employed to maintain a high flow rate across the membrane surface.

System 100 can employ a variety of different types of membranes as membrane 102. Such commercial membrane element types include, without limitation, hollow fiber membrane elements, tubular membrane elements, spiral-wound membrane elements, plate and frame membrane elements, and the like. Typical polymeric materials used to fabricate a membrane element include cellulose acetate and polyamide. Reverse osmosis typically uses spiral wound elements or modules, which are constructed by winding layers of semi-porous membranes with feed spacers and permeate water carriers around a central perforated permeate collection tube. Typically, the modules are sealed with tape and/or fiberglass over-wrap. The resulting construction may have one channel that can receive an inlet flow. The inlet stream flows longitudinally along the membrane module and exits the other end as a concentrate stream. Within the module, water can pass through the semi-porous membrane and is trapped in a permeate channel, which flows to a central collection tube. From this tube it can flow out of a designated channel and is collected.

In different applications, membrane 102 can be implemented using a single membrane element or multiple membrane elements depending on the application. For example, multiple membrane elements may be used forming membrane modules that are stacked together, end to end, with inter-connectors joining the permeate tubes of the first module to the permeate tube of the second module, and so on. These membrane module stacks can be housed in pressure vessels. Within the pressure vessel, the feed stream can pass into the first module in the stack, which removes a portion of the water as permeate water. The concentrate stream from the first membrane can then become the feed stream of the second membrane and so on down the stack. The permeate streams from all of the membranes in the stack can be collected in the joined permeate tubes.

Within some systems, pressure vessels may be arranged in either “stages” or “passes.” In a staged membrane system, the combined concentrate streams from a bank of pressure vessels can be directed to a second bank of pressure vessels where they become the feed stream for the second stage. Commonly, systems have two to three stages with successively fewer pressure vessels in each stage. For example, a system may contain four pressure vessels in a first stage, the concentrate streams of which feed two pressure vessels in a second stage, the concentrate streams of which in turn feeds one pressure vessel in the third stage. This is designated as a “4:2:1” array. In a staged membrane configuration, the combined permeate streams from all pressure vessels in all stages may be collected and used without further membrane treatment. Multi-stage systems are commonly used when large volumes of purified water are required. The permeate streams from the membrane system may be further purified by ion exchange or other means.

In a multi-pass system, the permeate streams from each bank of pressure vessels are collected and used as the feed to the subsequent banks of pressure vessels. The concentrate streams from all pressure vessels can be combined without further membrane treatment of each individual stream. Multi-pass systems are typically used when very high purity water is required, for example in the microelectronics or pharmaceutical industries. When system 100 is implemented as a reverse osmosis process, one or more membranes 102 may be configured as a multi-stage and/or multi-pass system.

While system 100 and membrane 102 may be implemented in a cross-flow filtration process, in other configurations, the system may be arranged for conventional filtration of suspended solids by passing the feed stream through a filter media or membrane in a substantially perpendicular direction. This arrangement can create one exit stream (e.g., purified stream 106) during the service cycle. Periodically, the filter may be backwashed by passing a clean fluid in a direction opposite to the feed, generating a backwash effluent containing species that have been retained by the filter. In this arrangement, system 100 may have a feed stream, a purified stream, and a backwash stream. This type of membrane separation is typically referred to as dead-end flow separation and is typically limited to the separation of suspended particles greater than about one micron in size.

In the system of FIG. 1, the wastewater feed supplied to membrane 100 can be chemically treated prior to contacting the membrane, e.g., to enhance separation efficiency and help prevent membrane fouling. In the configuration of FIG. 1, system 100 illustrates a source of oil-containing wastewater 110 and one or more treatment chemicals reservoirs 112A-112Z (collectively referred to as “treatment chemical 112”) fluidly connected to one or more respective more pump 114A-114Z (collectively referred to as “pump 114”). Pump 114 can operate to add one or more chemicals 112 (e.g., flocculant, surfactant, coagulant, pH adjuster) to the oil-containing wastewater from source 110. The one or more chemicals can be selected and added at concentrations as described above. FIG. 1 illustrates the treatment chemicals 112 being added inline with the oil-containing wastewater containing the treatment chemicals passing through a mixer 116 before contacting membrane 102. In other examples, as discussed above, the treatment chemicals may be added to a fixed volume of the oil-containing wastewater (e.g., in a treatment vessel upstream of membrane 102) or combined with the oil-containing wastewater in other ways.

In either case, the treatment chemicals can generate a treated wastewater that exhibits increased processability on membrane 102 as compared to direct treatment of the oil-containing wastewater from source 102. For example, oil-containing wastewater from source 102 may not pass through membrane 102 at or may not pass through the membrane on a commercially reasonably timescale. By contrast, the treated wastewater may fully pass through membrane 102 on a reasonable timescale.

After treatment using system 100, permeate 106 can be reused, recycled, or discarded (e.g., directly to the environment or after further treatment). In some examples, permeate 106 is supplied to a wastewater processing facility, either onsite with system 100 or physically remote from the location containing system 100, for further processing. The wastewater processing facility can be a private or municipal wastewater treatment facility the further processes permeate 106, making the permeate suitable for subsequent environmental discharge.

The following examples may provide additional details about oil-containing wastewater chemical treatment and membrane processing according to the disclosure.

### EXAMPLES

### Example 1—Use of Surfactant and Flocculant to Precondition Oily Wastewater Before Membrane Treatment

A surfactant and a flocculant were used to precondition oily wastewater before membrane treatment. The wastewater used in the example was a wastewater from an engine machining plant that had an unidentified concentration of oils and over 1,000 mg/L of suspended solids. Prior to pretreatment, the wastewater was passed through a ceramic tubular membrane to reduce the wastewater volume. However, the flux of membrane declined quickly during processing.

Three different samples of the wastewater were treated with treated with different pretreatment chemicals. The first sample was treated with only surfactant, specifically sodium dodecylbenzone sulfonate. The second sample was treated with only flocculant, specifically DMAEA.MCQ. The third sample was treated with surfactant followed by flocculant, specifically sodium dodecylbenzone sulfonate followed by.

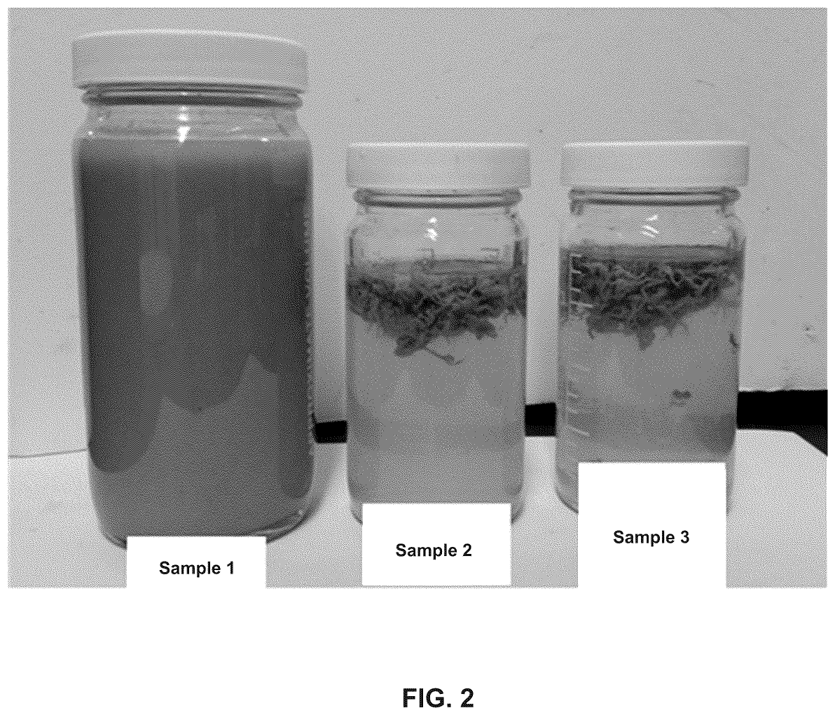

FIG. 2 shows three jars of the wastewater: one containing the raw wastewater labeled “Sample 1,” one treated with 1,000 mg/L flocculant alone and labeled “Sample 2,” and one treated with 1,000 mg/L flocculant and 500 mg/L surfactant and labeled “Sample 3.” As shown in FIG. 2, the raw wastewater was highly turbid due to suspended solids and potentially partially emulsified oils. The treated samples show a much more transparent water layer. Typically the transparency of the water suggests less membrane fouling, but the extent of membrane fouling is also affected by free oil contents in the water. Generally large solids floating on top do not directly foul a membrane.

A stirred cell experiment was performed to check the filterability of the untreated and treated wastewaters. In the stirred cell, a membrane coupon is placed in the bottom of the cell and the water sample is filled in the cell. Above the membrane, a magnetic stirrer spins to generate shear on membrane surface. The head space of the cell is pressurized using compressed air to push the water through membrane. Flux, which indicates the productivity of the membrane, is calculated based on the permeate flow rate.

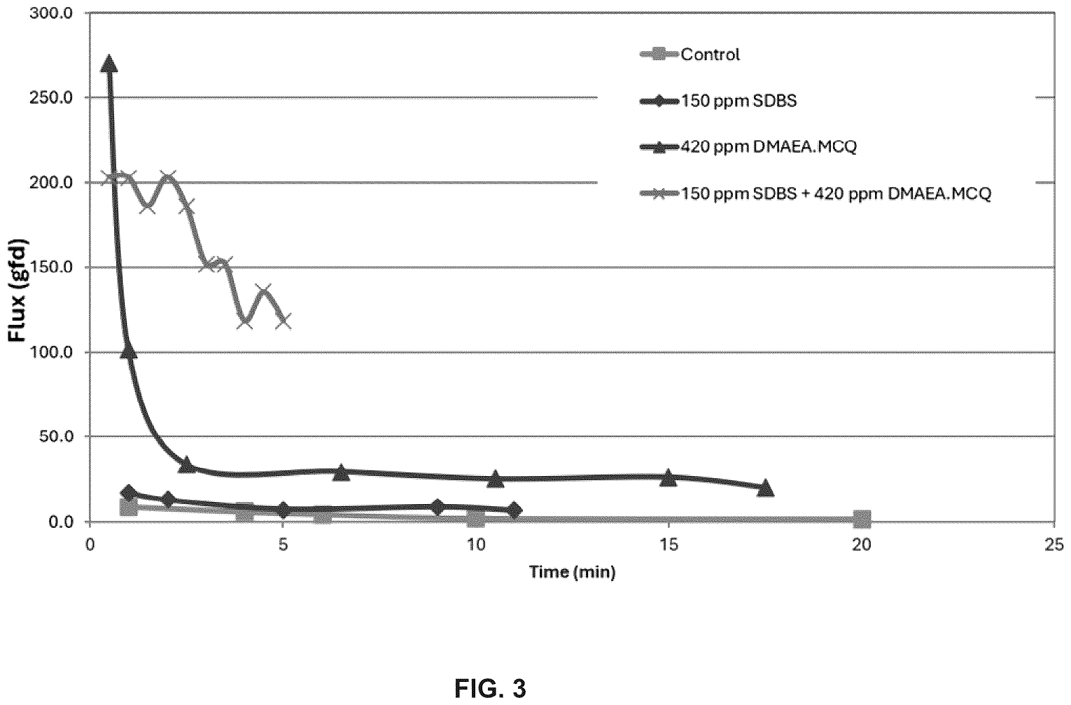

FIG. 3 shows flux data of various samples with and without preconditioning. In the control experiment in which the untreated wastewater was tested in the stirred cell experiment, the flux declined to less than 10 L/m2/hr (LMH) within a minute. For the sample preconditioned with 150 mg/L of sodium dodecylbenzone sulfonate alone (labeled “150 ppm SDBS”), the flux declined to less than 10 LMH after approximately 5 minutes. For the sample preconditioned with 1,000 mg/L of DMAEA.MCQ alone having an average molecular weight of 22 MDa (labeled “420 ppm DMAEA.MCQ”), the flux maintained greater than 20 LMH until all wastewater sample in the stirred cell was filtered. For the sample preconditioned with both 150 mg/L of sodium dodecylbenzone sulfonate and 420 mg/L of DMAEA.MCQ having an average molecular weight of 22 MDa (labeled “150 ppm SDBS+420 ppm DMAEA.MCQ”), the flux increased even further and, due to the high permeate flow rate, filtration ended quickly approximately three times faster than the sample with flocculant alone.

### Example 2—Use of Surfactant, Inorganic Coagulant, and Flocculant to Precondition Oily Wastewater Before Membrane Treatment

A wastewater sample was obtained from a die casting facility that used various types of oil- and silica-containing agents in the diecasting process. The wastewater was filtered both as a raw sample and after adding various pretreatment chemicals using the stirred cell experiment apparatus discussed under Example 1 above.

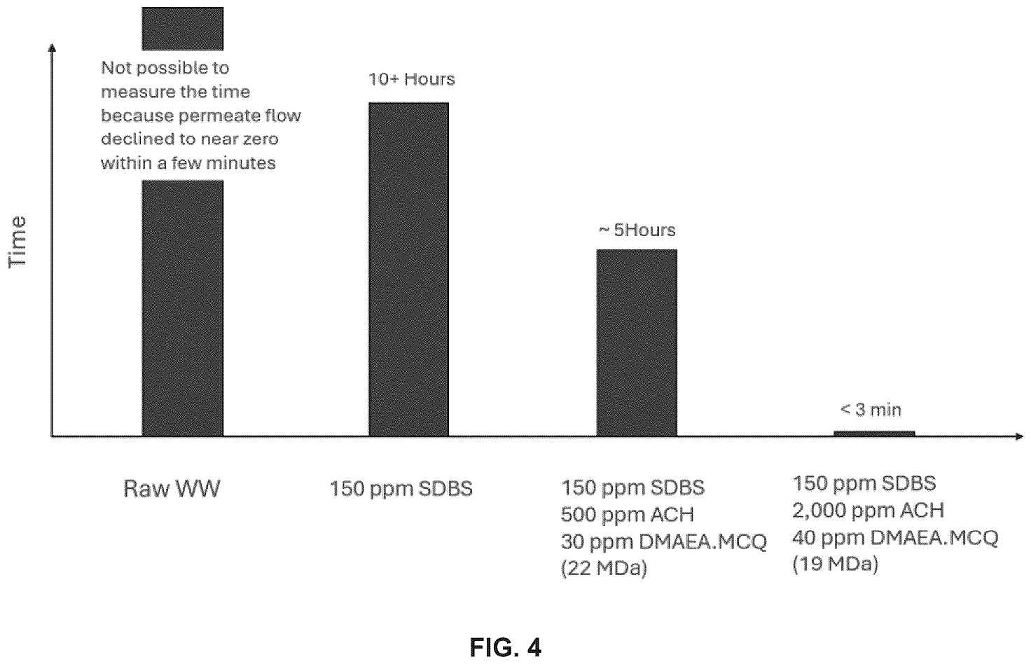

FIG. 4 is a bar graph showing the filterability of the wastewater under different pretreatment chemical conditions. The Y-axis of the chart shows the amount of time required to filter 200 ml of permeate from 250 ml of starting sample (either unconditioned or preconditioned).

In the control experiment in which the untreated wastewater was tested in the stirred cell experiment, the flux declined to an extremely low level immediately after the filtration started. It was not possible to obtain 200 ml of permeate from the sample within 16 hours. For the sample preconditioned with 150 mg/L of sodium dodecylbenzone sulfonate alone (labeled “150 ppm SDBS”), 200 ml of permeate was obtained after a little over 10 hours.

For the sample preconditioned with 150 mg/L of sodium dodecylbenzone sulfonate, 500 mg/L of an aluminum chlorohydrate coagulant and 30 mg/L of DMAEA.MCQ having an average molecular weight of 22 MDa (labeled “150 ppm SDBS/500 ppm ACH/30 ppm DMAEA.MCQ (22 MDa)”), it took approximately 5 hours to obtain 200 ml permeate. When the dosage of coagulant and flocculant was raised and a different cationic flocculant was used—specifically 150 mg/L of sodium dodecylbenzone sulfonate, 2,000 mg/L of an aluminum coagulant, and 40 mg/L of DMAEA.MCQ having an average molecular weight of 19 MDa (labeled “150 ppm SDBS/2,000 ppm ACH/40 ppm DMAEA.MCQ (19 MDa)”), filtration became dramatically easier, and it took only less than 3 minutes to obtain 200 ml of permeate.

### Example 3—Parametric Study of Concentration and Molecular Weight Changes

A set of parametric studies were conducted to evaluate the effect of different pretreatment chemistry concentrations and different flocculent molecular weights on filterability of an oil-containing wastewater. The wastewater tested was a wastewater from an aluminum die casting. The wastewater contained up to 1,000 ppm of oil and had contaminates that included silicone oil, hydrocarbon oil, and silica nanoparticles. Samples of the wastewater under different pretreatment conditions were evaluated in an AMICON® stirred cell as described in Example 1 above having a 0.45 micron polyvinylidendifluoride (PVDF) membrane. The samples were evaluated to determine the amount of time required to filter 200 ml of permeate from 250 ml of starting sample (either unconditioned or preconditioned).

Pretreatment chemicals used in the experimenter were a surfactant (sodium dodecyl benzene sulfonate), an inorganic coagulant (Aluminum chlorohydrate), and three different cationic polymeric flocculants having different molecular weights.

Table 1 below summarizes different pretreatment applied to the wastewater and compares the filter time for the samples to an untreated control of the wastewater.

| | Active Dosages (ppm) | | | Time to filter | Flocculant |
|---|---|---|---|---|---|
| | | Inorganic | | 200 ml | Polymer's MW |
| | Surfactant | Coagulant | Polymer | min | kDa |
| Control | 0 | 0 | 0 | 1,000+ | |
| Case 1 | 150 | 0 | 0 | 1,000+ | |
| Case 2 | 0 | 2,000 | 0 | 1,000+ | |
| Case 3 | 150 | 2,000 | 0 | 850 | |
| Case 4 | 150 | 2,000 | 100 | 730 | 160 |
| Case 5 | 150 | 2,000 | 100 | 141 | 1,200 |
| Case 6 | 150 | 2,000 | 100 | 1.3 | 18,600 |

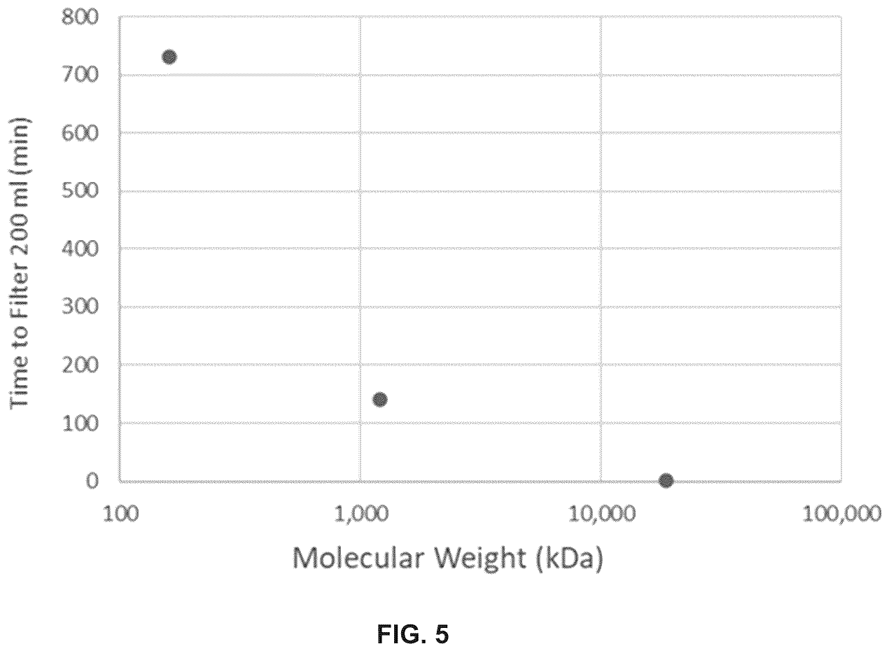

FIG. 5 is a plot of the filterability of the three wastewater samples treated with different molecular weight flocculants in Table 1 above. The Y-axis of the chart shows the amount of time required to filter 200 ml of permeate from 250 ml of starting sample. The X-axis of the chart shows the molecular weight of the flocculant used in pretreatment in kDa, with X-axis being in log scale. The data show the importance of using a high molecular weight flocculant in these examples.

1. A method of treating oil-containing water for membrane filtration, the method comprising:
adding a cationic polymeric flocculant having a molecular weight of at least 1,000,000 Da and a surfactant to an oil-containing wastewater to form a treated wastewater; and
supplying the treated wastewater to a membrane and generating therefrom a permeate stream and a concentrate stream.

2. The method of claim 1, wherein the molecular weight of the cationic polymeric flocculant is at least 5,000,000 Da.

3. The method of claim 1, wherein the cationic polymeric flocculant is selected from the group consisting of: a polydimethylaminoethylacrylate methyl chloride, a polydimethylaminoethylmethacrylate methyl chloride, a polydimethylaminoethylmethacrylate methyl sulfate, a polydimethylaminoethylacrylate methyl sulfate, a polydimethylaminoethylmethacrylate benzyl chloride, a polydimethylaminoethylacrylate benzyl chloride, a polytrimethylammonium propyl methacrylamide chloride, a polyacrylamidopropyltrimethylammonium chloride, an acrylamide-dimethylaminoethylacrylate methyl chloride copolymer, an acrylamide-dimethylaminoethylmethacrylate methyl chloride copolymer, an acrylamide-dimethylaminoethylmethacrylate methyl sulfate copolymer, an acrylamide-dimethylaminoethylacrylate methyl sulfate copolymer, an acrylamide-dimethylaminoethylmethacrylate benzyl chloride copolymer, an acrylamide-dimethylaminoethylacrylate benzyl chloride copolymer, an acrylamide-trimethylammonium propyl methacrylamide chloride copolymer, an acrylamide-acrylamidopropyltrimethylammonium chloride copolymer, and combinations thereof.

4. The method of claim 1, wherein the cationic polymeric flocculant has a cationic mole charge from 30% to 70%.

5. The method of claim 1, wherein the cationic polymeric flocculant comprises polydimethylaminoethylacrylate methyl chloride.

6. The method of claim 1, wherein adding the cationic polymeric flocculant to the oil-containing wastewater comprises adding an amount of the cationic polymeric flocculant effective to provide a concentration of the cationic polymeric flocculant in the treated wastewater of at least 25 ppm.

7. The method of claim 1, wherein adding the surfactant to the oil-containing wastewater comprises adding an amount of the surfactant effective to provide a concentration of the surfactant in the treated wastewater of at least 25 ppm.

8. The method of claim 1, wherein the surfactant comprises an anionic surfactant.

9. The method of claim 8, wherein the anionic surfactant is selected from the group consisting of: an alkyl aryl sulfonate, an olefin sulfonate, a paraffin sulfonate, an alcohol sulfate, an alcohol ether sulfate, an alkyl carboxylate, an alkyl ether carboxylate, an ethoxylated alkyl phosphate ester, a monoalkyl sulfosuccinate, a dialkyl sulfosuccinate, a monoalkyl sulfosuccinamate, a dialkyl sulfosuccinamate, and combinations thereof.

10. The method of claim 1, further comprising adding a coagulant to the oil-containing wastewater to form the treated wastewater.

11. The method of claim 10, wherein the coagulant comprises an inorganic metal salt.

12. The method of claim 10, wherein the coagulant comprises an organic polymeric coagulant.

13. The method of claim 10, wherein adding the coagulant to the oil-containing wastewater comprises adding an amount of the coagulant effective to provide a concentration of the surfactant in the treated wastewater from 10 ppm to 5000 ppm.

14. The method of claim 1, further comprising adding an acid and/or a base to the oil-containing wastewater to adjust a pH of the oil-containing wastewater and/or treated wastewater.

15. The method of claim 1, wherein the oil-containing wastewater comprises at least 25 mg/L of oil.

16. The method of claim 1, wherein the oil-containing wastewater comprises suspended solids at a concentration of at least 10 mg/L.

17. The method of claim 16, wherein the suspended solids comprise at least 50 wt % silica.

18. The method of claim 1, wherein the oil-containing wastewater comprises wastewater from a metal milling process and/or a die casting process.

19. The method of claim 1, comprising allowing the cationic polymeric flocculant and the surfactant to interact with the oil-containing wastewater for a period of at least 30 seconds before supplying the treated wastewater to the membrane.

20. A method of treating oil-containing water for membrane filtration, the method comprising:
adding a cationic polymeric flocculant having a molecular weight of at least 1,000,000 Da, a coagulant, and a surfactant to an oil-containing wastewater to form a treated wastewater, wherein the oil-containing wastewater comprises wastewater from a metal milling process and/or a die casting process; and
supplying the treated wastewater to a membrane and generating therefrom a permeate stream and a concentrate stream.

21. The method of claim 20, wherein the molecular weight of the cationic polymeric flocculant is from 5,000,000 Da to 25,000,000 Da.

22. The method of claim 20, wherein:
adding the cationic polymeric flocculant to the oil-containing wastewater comprises adding an amount of the cationic polymeric flocculant effective to provide a concentration of the cationic polymeric flocculant in the treated wastewater of at least 0.1 ppm;
adding the surfactant to the oil-containing wastewater comprises adding an amount of the surfactant effective to provide a concentration of the surfactant in the treated wastewater of at least 25 ppm; and
adding the coagulant to the oil-containing wastewater comprises adding an amount of the coagulant effective to provide a concentration of the surfactant in the treated wastewater from 500 ppm to 5000 ppm.
